(19) United States
(12) Patent Application Publication
(10) Pub. No.: US 2017/0285696 A1
(43) Pub. Date: Oct. 5, 2017

(54) Method and Apparatus for Mounting Power Supplies in Rack-Mountable Computer Chassis

(71) Applicant: Steven L. Magnusson, Round Rock, TX (US)

(72) Inventor: Steven L. Magnusson, Round Rock, TX (US)

(21) Appl. No.: 15/090,584

(22) Filed: Apr. 4, 2016

(51) Int. Cl. G06F 1/18; G06F 1/20

(52) U.S. Cl. CPC G06F 1/183; G06F 1/181; G06F 1/20; G06F 1/189

(57) ABSTRACT

An electronic equipment chassis adapted to house a motherboard includes a side, a back, and a mid-plane support. A carrier for housing at least one power supply is disposed within the electronic equipment chassis. The carrier is supported by the back and mid-plane support. The carrier does not intersect a horizontal plane of the motherboard.

### FIELD OF THE INVENTION

The invention relates to method and apparatus for mounting power supplies in rack-mountable electronic equipment chassis such as computer chassis.

### BACKGROUND

Racks are an efficient structure for carrying electronic equipment. Racks are typically metal frame structures with shelves or rails to support the electronic equipment. Computer chassis are often rack-mountable to enable dense installations of computers.

Organizations such as the Electronics Industry Association (“EIA”) have developed standards to ensure fitment compatibility. The EIA, for example, has developed a specification for what is commonly known as the 19-inch rack. This specification standardizes several features of 19-inch racks such as the rack unit (U), vertical hole spacing, horizontal hole spacing, front panel width, and rack opening. The specification also sets tolerances on each of these dimensions.

A rack unit or “U” is a standard unit of measure for designating vertical rack space capacity and vertical space consumption. Each U is 1.75 inches. The number of U is a capacity measurement for the rack. For rack mountable electronic equipment, the number of U indicates how much vertical space in units of U the electronic equipment consumes when mounted. An 18U rack, for example, can accommodate 18 1U servers or 9 2U servers or 6 3U servers or 6 2U and 2 3U servers, and so forth.

Rack mounting allows for a higher density of computing capability, consolidation of network resources, simplification of cabling between components, cable management, reduction in horizontal footprint, and simplifying addition, removal, and replacement of the electronic equipment or components within the electronic equipment (i.e., serviceability).

The horizontal mounting hole spacing set forth in the EIA-310-D specification is 465 mm. This specification limits the maximum possible open horizontal distance between rails to approximately 455 mm. The specification imposes a 450 mm minimum distance. Manufacturers of rack-mountable equipment should not exceed a 450 mm width to ensure fitment in a 19-inch rack.

Serviceability of individual electronic equipment concerns the ability to access the electronic equipment as well as components within the electronic equipment. Computers have motherboards which contain the central processing unit, main system memory, non-volatile memory, circuitry for controlling peripheral devices, and slots to permit expansion by adding peripheral devices. Motherboards are generally planar board with these other components mounted on them or inserted into them. The motherboard for an individual rack-mountable computer should be easy to install or remove—or to access to add, remove, or exchange peripheral devices. For example, the motherboard expansion slots should be accessible for removing, installing, or swapping out memory cards, controller cards, video cards, and other peripherals. A motherboard is also referred to as a main, base, logic, or system board.

In order to facilitate serviceability of a motherboard, one chassis design approach fixes a carrier 120 for housing one or more power supplies on the side of the remainder of the chassis 110 as shown in FIG. 1. The motherboard is installed as can be seen from the motherboard external input/output interface 160. The carrier provides for easy addition, removal, or replacement of modular power supplies 126, 128 externally. However, the installed carrier intersects or shares the horizontal plane that the motherboard resides in. The width of the motherboard combined with the maximum open space width for the rack imposes width constraints on the carrier. If the carrier provides multiple bays as illustrated to support power supply redundancy, the height of the individual modular power supply is also significantly constrained. Although the motherboard may be easily accessed, the output capacity of the power supply is significantly constrained due to the volumetric limitations of the carrier power supply bays.

Another approach is illustrated in FIG. 2. A removable carrier 220 for power supply 250 is placed in the remainder of the chassis 210. This approach mounts the removable carrier above the motherboard and thus does not share any part of the horizontal width constraints with the motherboard. This approach allows for higher capacity power supplies with the tradeoff of reduced serviceability of the motherboard. In particular, although the carrier need not necessarily be removed to add, remove, or exchange peripheral devices on the motherboard, the carrier must be removed in order to remove or exchange the motherboard. Power supply serviceability is also reduced because the power supply or power supplies are not modularized for external removability. The carrier also relies on an additional support bracket 222 which increases the time and effort required to remove the carrier to service the motherboard.

### SUMMARY

An electronic equipment chassis adapted to house a motherboard includes a side, a back, and a mid-plane support. A carrier for housing at least one power supply is disposed within the electronic equipment chassis. The carrier is supported by the back and mid-plane support. The carrier does not intersect a horizontal plane of the motherboard.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates a prior art rack-mountable chassis for a computer.

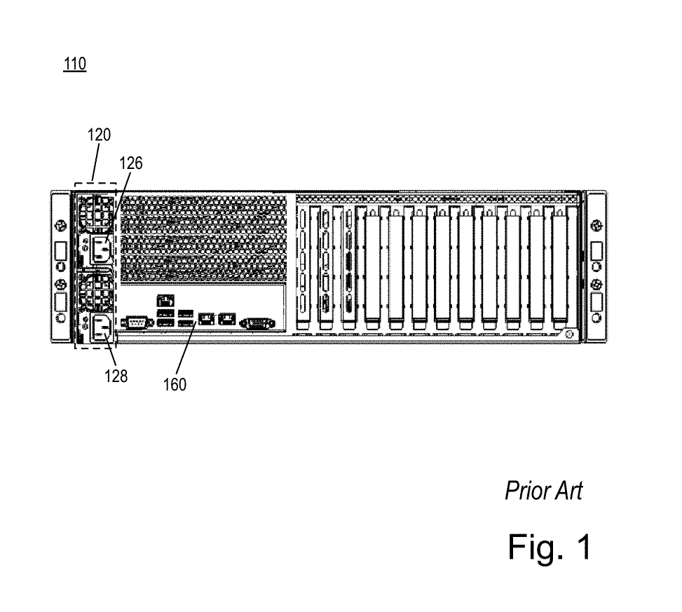

FIG. 2 illustrates another prior art rack-mountable chassis for a computer.

FIG. 3 illustrates another view of the prior art rack-mountable chassis of FIG. 2.

FIG. 4 illustrates a prior art mid-plane support.

FIG. 5 illustrates one embodiment of an improved mid-plane support of the present invention.

FIG. 6 illustrates one view of a chassis including a power supply carrier of the present invention.

FIG. 7 illustrates a rear view of a chassis including a power supply carrier of the present invention.

FIG. 8 illustrates an alternative rear view of a chassis including a power supply carrier of the present invention.

### DETAILED DESCRIPTION

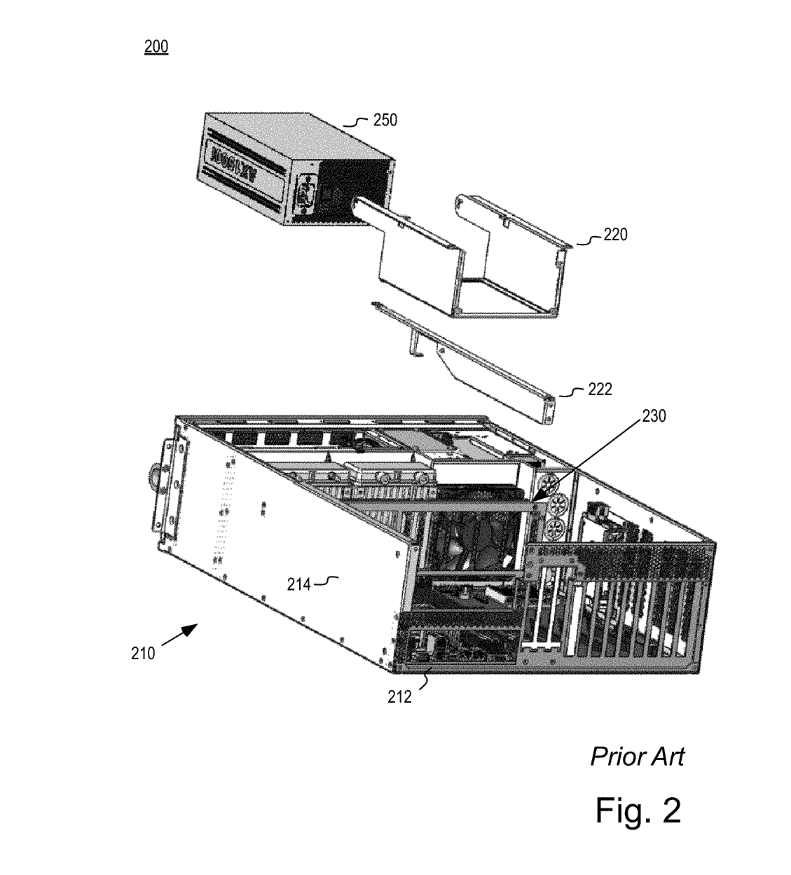

FIG. 2 illustrates a prior art apparatus for supporting a power supply 250 for a rack-mountable computer chassis 210. The power supply is placed in carrier 220. A support 222 is fastened to the carrier. The back 212 of the chassis provides support for one end of the carrier. The front of the carrier is supported at least in part by the support bracket 222 which is itself supported by a mid-plane support 230.

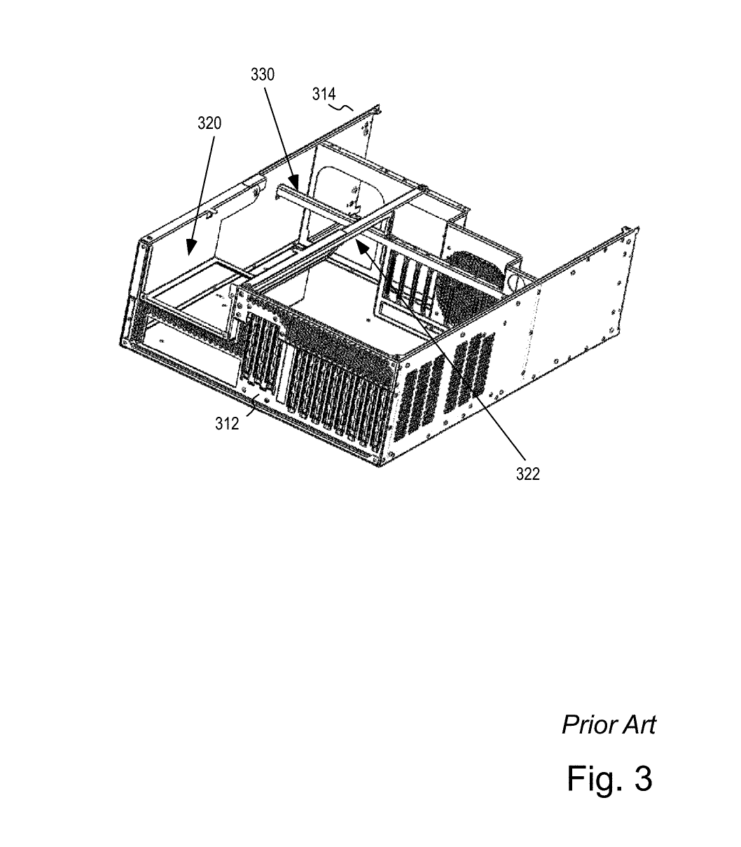

FIG. 3 illustrates an alternative view of the prior art power supply support apparatus of FIG. 2. The carrier 320 is supported by the back 312 of chassis 310, by the side 314 of the chassis, and by a mid-plane support 330 through the use of the support bracket 322.

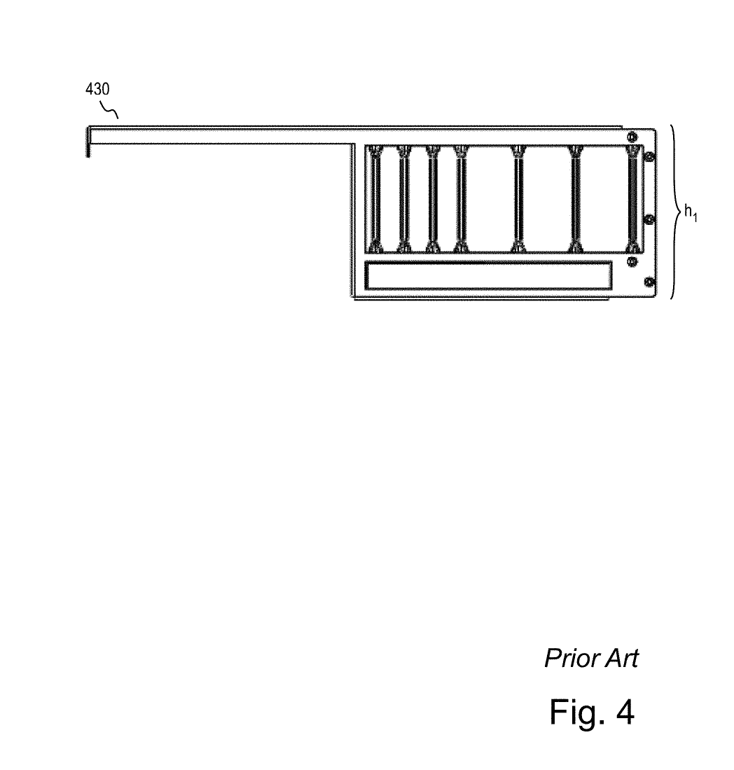

FIG. 4 illustrates the prior art mid-plane support 430. Notably the support has a uniform height, h₁.

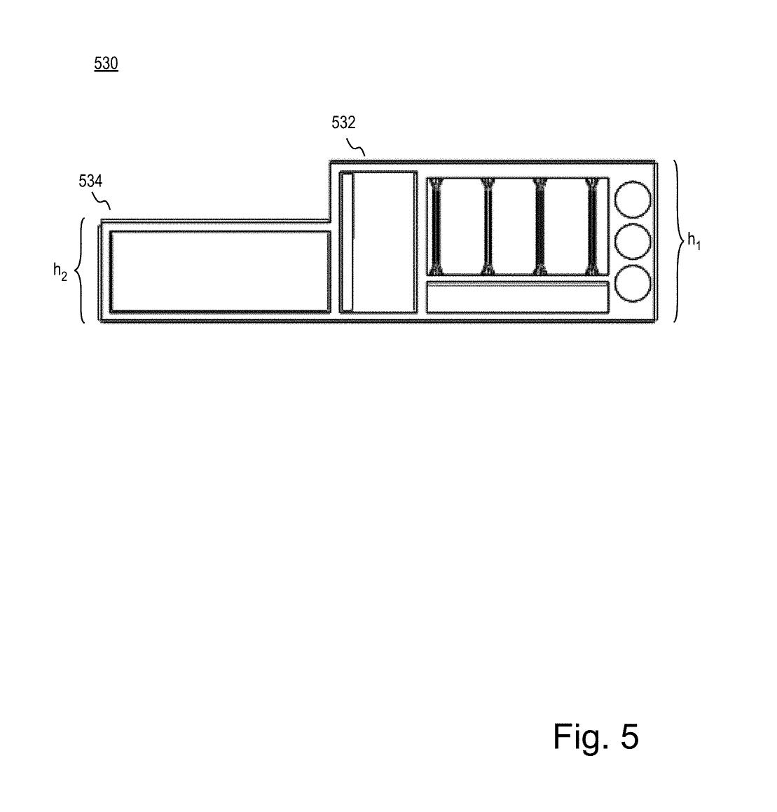

FIG. 5 illustrates one embodiment of an improved mid-plane support 530 of the present invention. In particular, the mid-plane support includes at least a portion 534 which is not full-height h₁ such as portion 532. In this instance the mid-plane support has at least a portion 534 with a height h₂ such that the carrier of the present invention can be accommodated between a cover (or the top of the chassis sides) of the equipment and the mid-plane support.

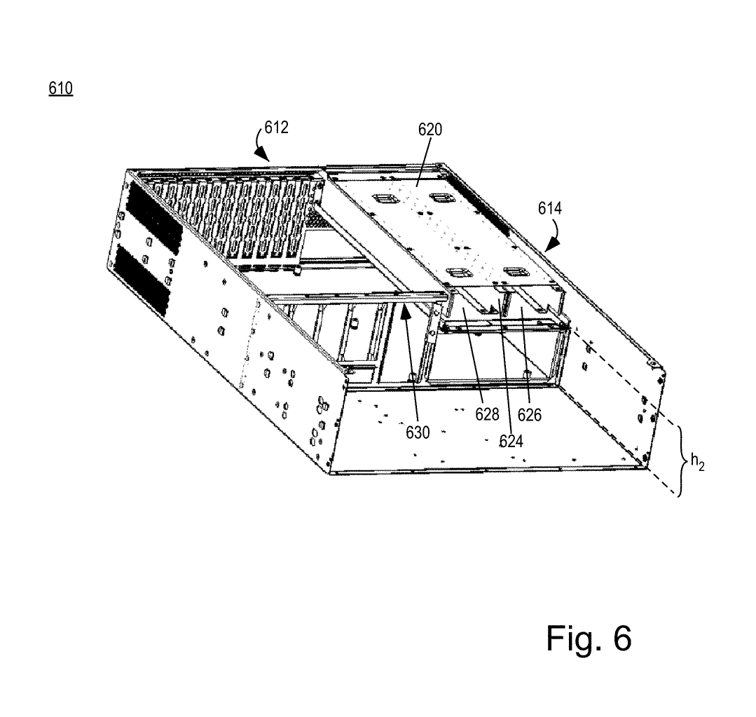

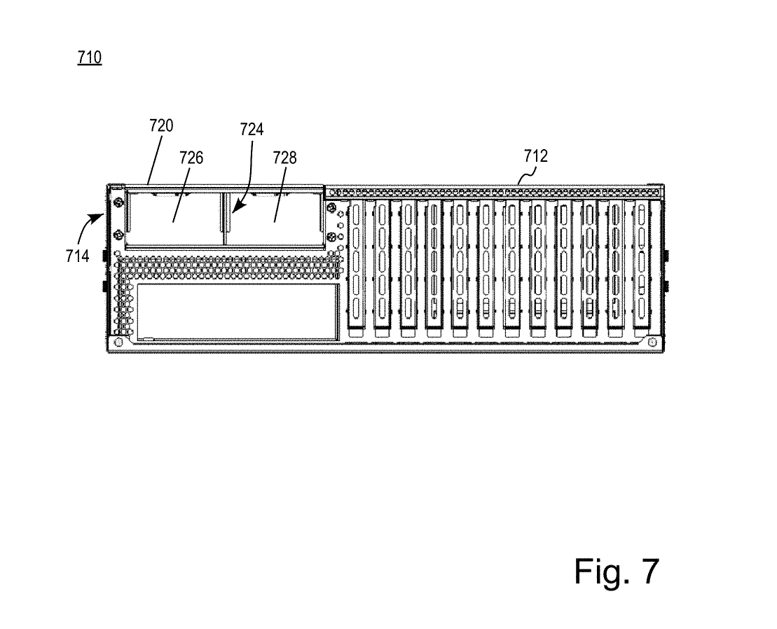

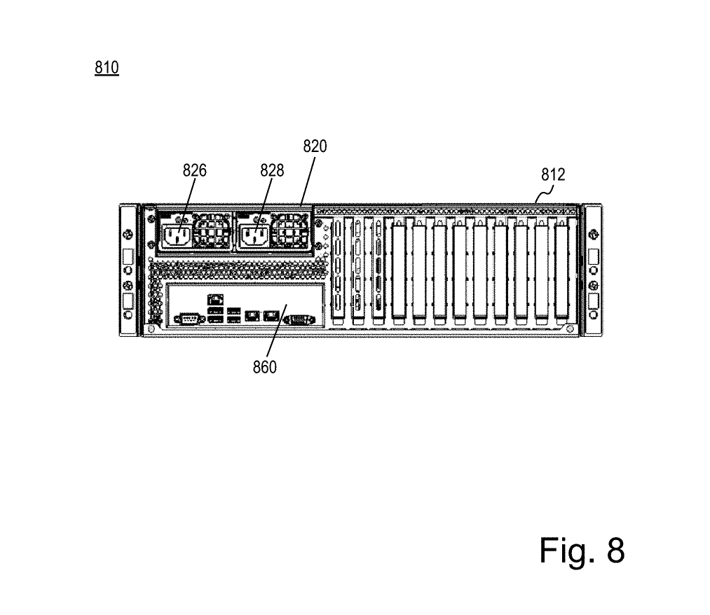

FIG. 6 illustrates one view of a chassis 610 of the present invention including a power supply carrier 620. In this embodiment a separator 624 is disposed within carrier 620 to create two power supply module bays 626, 628. The front end of the carrier rests on mid-plane support 630. Mid-plane support 630 and the back of the chassis (shown in FIGS. 7-8) support the carrier. The height h₂ is the same height as a corresponding support on the back of the chassis when measured from the same horizontal reference plane.

FIG. 7 illustrates a rear view of the chassis 710. The chassis is shown without the motherboard or power supply modules in this embodiment. The back 712 of the chassis has a cut out to support the carrier 720. The carrier in this case includes a separator 724 to create two power module bays 726, 728. The carrier is supported by the chassis back 712, side 714, and mid-plane support (see FIG. 6 regarding the mid-plane support). The carrier is positioned above where the motherboard would be located. The motherboard and the carrier do not share any common horizontal plane. In one embodiment, screws or other fasteners are used to secure the carrier to one or more of the chassis back, side, or mid-plane support.

FIG. 8 illustrates another rear view of the chassis 810. The motherboard is installed as can be seen from the motherboard external input/output interface 860 accessible from the back 812 of the chassis. In one embodiment, the carrier is disposed relative to the motherboard so as not to interfere with or obstruct vertical space needed to populate motherboard expansion slots.

The carrier 820 is populated with removable power supply modules 826, 828, one in each bay. In alternative embodiments the carrier may be configured for a single power supply module rather than multiple power supply modules.

Removable power supply modules rely on a socket for communicating with and delivering power to the motherboard. With reference to FIG. 2, instead of connecting cables from power supply 250 to a motherboard and peripherals, the cables are connected to the peripherals and motherboard from a socket compatible for receiving the power supply modules. The selection and placement of such sockets is within the knowledge of one skilled in the art of manufacturing electronic equipment with removable power supply modules.

In one embodiment, the electronic equipment relies on liquid cooling for managing the temperature of critical components. Liquid cooling provides for better transfer of thermal energy away from critical components. In addition, because of the greater thermal transfer capability of liquid cooling, slower and quieter fans can be utilized thus reducing the noise output from the equipment. Candidates for liquid cooling include the central processing unit and graphical processing units, for example. The greater cooling capabilities allows for higher clock speeds for processors. Higher clock speeds typically require greater amounts of power and thus larger capacity power supplies to meet the power demands. The carrier as disclosed herein permits larger volume (and therefore generally larger capacity) power supplies to support the faster processors.

An electronic equipment chassis including a side, a back, and a mid-plane support has been described for an electronic equipment chassis adapted to house a motherboard. A carrier for housing at least one power supply is disposed within the electronic equipment chassis and supported by the back and mid-plane support of the electronic equipment chassis. The installed carrier does not intersect a horizontal plane of the motherboard.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. An apparatus comprising:
an electronic equipment chassis including a side, a back, and a mid- plane support, wherein the electronic equipment chassis is adapted to house a motherboard; and
a carrier for housing at least one power supply, wherein the carrier is disposed within the electronic equipment chassis, wherein the carrier is supported by the back and mid-plane support of the electronic equipment chassis, wherein the carrier does not intersect a horizontal plane of the motherboard.

2. The apparatus of claim 1 wherein the carrier includes at least one separator to create a plurality of carrying bays.

3. The apparatus of claim 1 wherein the carrier is also supported by the side of the chassis.

4. The apparatus of claim 1 wherein the electronic equipment is a computer.

5. The apparatus of claim 1 wherein the mid-plane support is not a uniform height.

6. The apparatus of claim 5 wherein a top of the mid-plane support varies in height from a bottom of the mid-plane support such that a first portion has a uniform height h₁ and a second portion has a uniform height h₂.

7. The apparatus of claim 1 further comprising a removable power supply module disposed within the carrier.

8. The apparatus of claim 1 wherein the carrier provides a plurality of receiving bays.

9. The apparatus of claim 8 wherein at least one receiving bay is populated with a removable power supply module.

10. The apparatus of claim 1 wherein the electronic equipment chassis is rack-mountable.

11. An apparatus comprising:
a computer chassis including a side, a back, and a mid-plane support, wherein the computer chassis is adapted to house a motherboard; and
a carrier for housing at least one power supply, wherein the carrier is disposed substantially within the computer chassis, wherein the carrier is supported by the back and mid-plane support of the computer chassis, wherein the carrier does not intersect a horizontal plane of the motherboard.

12. The apparatus of claim 11 wherein the carrier includes at least one separator to create a plurality of carrying bays.

13. The apparatus of claim 11 wherein the carrier is also supported by the side of the chassis.

14. The apparatus of claim 11 wherein the mid-plane support is not a uniform height.

15. The apparatus of claim 14 wherein a top of the mid-plane support varies in height from a bottom of the mid-plane support such that a first portion has a uniform height h₁ and a second portion has a uniform height h₂.

16. The apparatus of claim 11 further comprising a removable power supply module disposed within the carrier.

17. The apparatus of claim 11 wherein the carrier provides a plurality of receiving bays.

18. The apparatus of claim 17 wherein at least one receiving bay is populated with a removable power supply module.

19. The apparatus of claim 11 wherein the computer chassis is rack- mountable.

20. The apparatus of claim 11 wherein a central processing unit of the motherboard is liquid-cooled.
